(19) United States
(12) Patent Application Publication
(10) Pub. No.: US 2012/0078711 A1
(43) Pub. Date: Mar. 29, 2012

(54) AUTOMATED LOCAL ADVERTISING INTERFACE

(76) Inventors: Bhavesh R. Mehta, Cupertino, CA (US); Kiley McEvoy, San Franciso, CA (US); Xuefu Wang, Los Altos, CA (US); Abhinav Jalan, Sunnyvale, CA (US); Ankur Jain, Mountain View, CA (US); Xinyu Tang, Cupertino, CA (US); David Minogue, Cupertino, CA (US)

(21) Appl. No.: 12/892,891

(22) Filed: Sep. 28, 2010

(51) Int. Cl. G06Q 30/00

(52) U.S. Cl. 705/14.45; 705/14.72; 705/14.69

(57) ABSTRACT

Systems, methods, and computer program products for automating local content are described. In some implementations, an ad manager and a business table can be provided by a backend system. The business table can store, for example, user information, user account information including billing information, campaign related information and advertisement data associated with one or more local business advertisers as well as geo-targeting information. Based on the information stored in the business table, the ad manager can tailor a specific online advertising campaign on behalf of a local business advertiser. Where new or updated information is found, the ad manager can initiate campaign management updates to one or more business ad listings associated with the local business advertiser.

### TECHNICAL FIELD

The subject matter of this application is generally related to information presentation.

### BACKGROUND

Local search is a segment of the online search marketplace where users attempt to find desired information about products, services or businesses which meet the users' geographic searching criteria. Local search can provide a user-directed advertising venue that offers fairly precise targeting capabilities at low costs per lead.

### SUMMARY

Systems, methods, and computer program products for automating local content are described. In some implementations, an ad manager and a business table can be provided by a backend system. The business table can store, for example, user information, user account information including billing information, campaign related information and advertisement data associated with one or more local business advertisers as well as geo-targeting information. Based on the information stored in the business table, the ad manager can tailor a specific online advertising campaign on behalf of a local business advertiser. Where new or updated information is found, the ad manager can initiate campaign management updates to one or more business ad listings associated with the local business advertiser.

In some implementations, a method can be provided that includes receiving a request to generate an advertisement for an advertisement campaign of an entity and an advertisement request for presentation of the advertisement; receiving campaign information associated with the entity including receiving local business information associated with the entity; identifying geographic data related to the advertisement request including determining an intersection of the geographic data and the local business information; automatically, without user intervention, generating one or more keywords to be associated with the advertisement based on the received campaign information; generating the advertisement based on the campaign information and the one or more generated keywords; automatically, without user intervention, managing the advertisement campaign including adjusting one or more bids associated with the one or more generated keywords; and presenting a local advertisement in response to the advertisement request based on the determined intersection.

In some implementations, a computer-readable medium can be provided that includes instructions stored thereon, which, when executed by a processor, causes the processor to perform operations comprising: receiving a request to generate an advertisement for an advertisement campaign of an entity and an advertisement request for presentation of the advertisement; receiving campaign information associated with the entity including receiving local business information associated with the entity; identifying geographic data related to the advertisement request including determining an intersection of the geographic data and the local business information; automatically, without user intervention, generating one or more keywords to be associated with the advertisement based on the received campaign information; generating the advertisement based on the campaign information and the one or more generated keywords; automatically, without user intervention, managing the advertisement campaign including adjusting one or more bids associated with the one or more generated keywords; and presenting a local advertisement in response to the advertisement request based on the determined intersection.

In some implementations, a system can be provided that includes an advertisement manager to: generate an interface and receive, through the interface, a request to generate an advertisement for an advertisement campaign of an entity, and campaign information associated with the entity; a keyword generator to automatically, without user intervention, generate one or more keywords to be associated with the advertisement based on the received campaign information; and a bid manager to automatically, without user intervention, manage the advertisement campaign and adjust one or more bids associated with the one or more generated keywords.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram showing an example content presentation system.

FIG. 2 is a data flow diagram showing an example data flow.

FIG. 3 shows an example of a business ad listing interface displaying a business ad listing page from which a business advertisement can be created.

FIG. 4 shows an example of a setup interface through which a local business online campaign can be created.

FIG. 5 shows an example of a budget recommendation chart from which a local business advertiser can reference one of several bidding and spending management options.

FIG. 6 shows an example of a statistics page that can be presented to a local business advertiser after a local business ad listing has been created.

FIG. 7 shows an example of a process for presenting content to a user.

FIG. 8 is a block diagram of generic processing device that may be used to execute methods and processes disclosed herein.

Like reference symbols in the various drawings indicate like elements.

### DETAILED DESCRIPTION

### System Overview

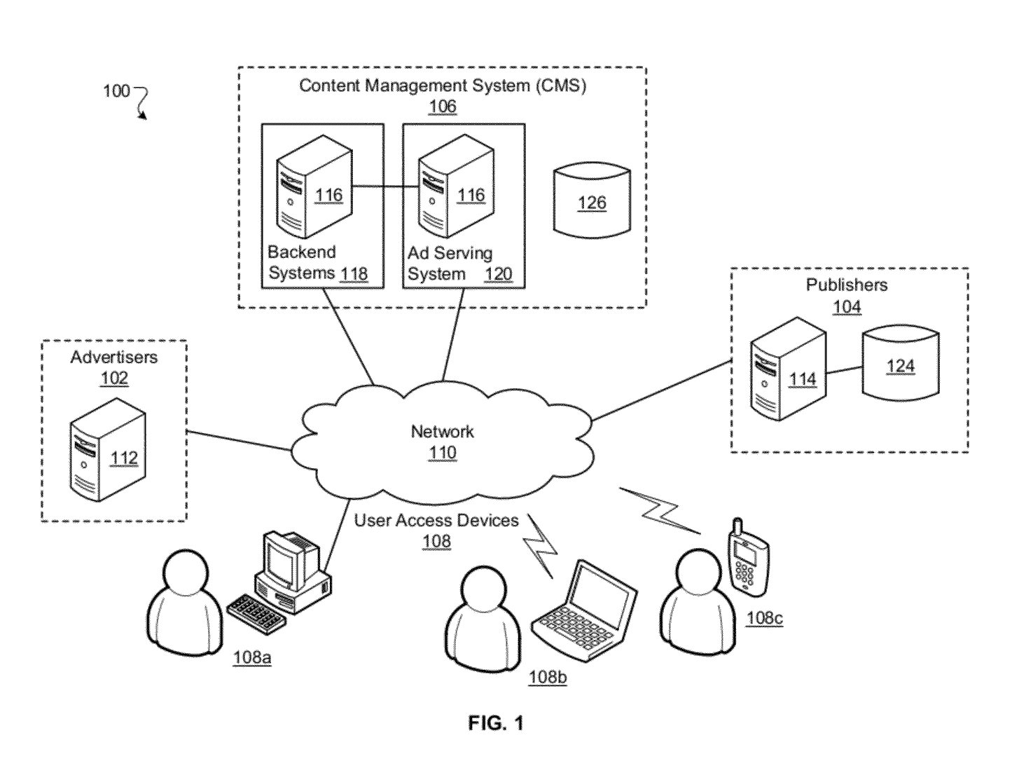

FIG. 1 is a block diagram showing an example content presentation system 100. The system 100 can receive and provide content to users, publishers, and advertisers. For example, the content can include web documents, links, images, advertisements, and other information. In some implementations, the system 100 can receive content from advertisers and deliver or serve the advertiser content to users when the users' access content is associated with publishers (e.g., a publisher web page). In some implementations, the system 100 can select and deliver advertiser content that is contextually relevant and of an appropriate format and style to the publisher content accessed.

In some implementations, content can include one or more advertisements. An advertisement or an “ad” can refer to any form of communication in which one or more products, services, ideas, messages, people, organizations or other items are identified and promoted. Ads need not be limited to commercial promotions or other communications. An ad can be a public service announcement or any other type of notice, such as a public notice published in printed or electronic press or a broadcast. An ad can be referred to or include sponsored content.

In some implementations, ads can be communicated via various mediums and in various forms. For example, ads can be communicated through an interactive medium, such as the internet, and can include graphical ads (e.g., banner ads), textual ads, image ads, audio ads, video ads, ads combining one of more of any of such components, or any form of electronically delivered advertisement. Ads can include embedded information, such as embedded media, links, meta-information, and/or machine executable instructions. Ads can also be communicated through RSS (Really Simple Syndication) feeds, radio channels, television channels, print media, and other media.

The term “ad” can refer to either a single “creative” and/or an “ad group.” A creative can be any content that represents one ad impression. An ad impression refers to any form of presentation of an ad such that it is viewable/receivable to a user. In some implementations, an ad impression can occur when displaying an ad on a display device of a user access device. An ad group can be an entity that represents a group of creatives that share a common characteristic, such as having the same ad targeting criteria. Ad groups can be used to create an ad campaign.

In some implementations, ads can be embedded within other content. For example, ads (e.g., newspaper subscription advertisement) can be displayed with other content (e.g., newspaper articles) in a web page associated with a publisher (e.g., a news content provider). When displayed, the ads can occupy an ad space “slot” or “block.” Ad space can include any space that allows rendering/presentation of information (i.e., associated with a given ad). In some examples, the ad space can be implemented as a HyperText Markup Language (HTML) element, such as an inline frame (I-Frame) or other type of embeddable display element. The ad space can include any portion, or all, of a user display. The ad space can be a discrete, isolated portion of a display or blended and dispersed throughout a display. The ad space can be a discrete element or dispersed in multiple sub-elements.

In some implementations, ads can be integrated with the surrounding content of the web page they are displayed with, prior to viewing by a user. For example, the rendering of the text of an ad can be in the same or a complementary size, color, and font type as the text on the web page into which it is integrated. In addition, the ad can be displayed using the same color scheme or chrome of the surrounding web page into which it is integrated. Typically, the better integrated into its web page surroundings an ad is, the better the ad will perform in terms of notice and interaction by a user.

In some implementations, the advertising system 100 can dynamically determine how to render/present an ad. For example, the advertising system 100 can determine how much space a particular ad can occupy. Moreover, the advertising system 100 can determine if the ad can be expanded, shrunk, side-barred, bannered, popped up, or otherwise displayed alone or with other ads within a specific publisher's website. For example, the advertising system 100 can use ad features (e.g., title, text, links, executable code, images, audio, embedded information, targeting criteria, etc.) to identify if an ad can be served in a particular ad block.

In determining how to render/present an ad, the advertising system 100 can determine how to best integrate the ad into its web page surroundings. Prior to rendering the ad, the advertising system 100 can determine specific data related to the web page (e.g., types of fonts used, colors, font sizes, color scheme used by the web page, etc.). Using this data, the advertising system 100 can select fonts, colors, font sizes, chromes, etc. that can best render the ad in order for it to integrate well into the web page.

A “click-through” of a displayed ad can occur when a user clicks or otherwise selects/interacts with the ad. A “conversion” can occur when a user consummates a transaction related to a given ad. For example, a conversion can occur when a user clicks on an ad, which refers them to the advertiser's web page, and consummates a purchase on the advertiser's web page before leaving that web page. In another example, a conversion can be the display of an ad to a user and a corresponding purchase on the advertiser's web page within a predetermined time (e.g., seven days).

As shown in FIG. 1, the advertising system 100 can include one or more content providers (e.g., advertisers 102), one or more publishers 104, a content management system (CMS) 106, and one or more user access devices 108 (user access device 108a, user access device 108b, user access device 108c). All of the elements can be coupled to a network 110. Each of the elements 102, 104, 106, 108, and 110 in FIG. 1 can be implemented or associated with hardware components, software components, or firmware components, or any combination of such components. For example, the elements 102, 104, 106, 108, and 110 can be implemented or associated with general purpose servers, software processes and engines, and/or various embedded systems. For example, the elements 102, 104, 106, and 110 can serve as an ad distribution network. While reference is made to distributing advertisements, the system 100 can be suitable for distributing other forms of content including other forms of sponsored content.

The advertisers 102 can include any entities that are associated with ads. The advertisers 102 can provide, or be associated with, products and/or services related to ads. For example, the advertisers 102 can include, or be associated with, retailers, wholesalers, warehouses, manufacturers, distributors, health care providers, educational establishments, financial establishments, technology providers, energy providers, utility providers, or any other product or service providers or distributors.

The advertisers 102 can directly or indirectly generate, maintain, and/or track ads, which can be related to products or services offered by or otherwise associated with the advertisers. The advertisers 102 can include, or maintain, one or more data processing systems 112, such as servers or embedded systems, coupled to the network 110. The advertisers 102 can include or maintain one or more processes that run on one or more data processing systems.

The publishers 104 can include any entities that generate, maintain, provide, present, and/or process content in the advertising system 100. The publisher “content” can include various types of content including web-based information, such as articles, discussion threads, reports, analyses, financial statements, music, video, graphics, search results, web page listings, information feeds (e.g., RSS feeds), television broadcasts, radio broadcasts, printed publications, etc. The publishers 104 can include or maintain one or more data processing systems 114, such as servers or embedded systems, coupled to the network 110. The publishers 104 can include or maintain one or more processes that run on data processing systems. In some implementations, the publishers 104 can include one or more content repositories 124 for storing content and other information.

In some implementations, the publishers 104 can include content providers. For example, content providers can include those with an internet presence, such as online publication and news providers (e.g., online newspapers, online magazines, television websites, etc.), or online service providers (e.g., financial service providers, health service providers, etc,). The publishers 104 can also include television broadcasters, radio broadcasters, satellite broadcasters, print publishers and other content providers. One or more of the publishers 104 can represent a content network that is associated with the CMS 106.

In some implementations, the publishers 104 can include search services. For example, search services can include those with an internet presence, such as online search services that search the worldwide web, online knowledge database search services (e.g., dictionaries, encyclopedias), etc.

The publishers 104 can provide or present content via various mediums and in various forms, including web based and non-web based mediums and forms. The publishers 104 can generate and/or maintain such content and/or retrieve the content from other network resources.

The CMS 106 can manage content (e.g., ads) and provide various services to the advertisers 102, the publishers 104, and the user access devices 108. The CMS 106 can store ads in a repository 126 and facilitate the distribution or targeting of ads through the advertising system 100 to the user access devices 108.

The CMS 106 can include one or more data processing systems 116, such as servers or embedded systems, coupled to the network 110. The CMS 106 can also include one or more processes, such as server processes. In some implementations, the CMS 106 can include an ad serving system 120 and one or more backend processing systems 118. The ad serving system 120 can include one or more data processing systems 116 and can perform functionality associated with delivering ads to publishers or user access devices. The backend processing systems 118 can include one or more data processing systems 116. The backend processing systems 118 can perform functionality associated with identifying relevant ads to deliver, customizing ads, performing filtering processes, generating reports, maintaining accounts and usage information, and other backend system processing. The CMS 106 can use the backend processing systems 118 and the ad serving system 120 to distribute ads from the advertisers 102 through the publishers 104 to the user access devices 108.

In some implementations, the CMS 106 can provide various features to the publishers 104. The CMS 106 can deliver ads (associated with the advertisers 102) to the user access devices 108 when users access content from the publishers 104. For example, the CMS 106 can deliver ads that are relevant to publisher sites, site content, and publisher audiences. In another example, the CMS 106 can allow the publishers 104 to search and select specific products and services as well as associated ads displayed with content provided by the publishers 104. In some implementations, the publishers 104 can search through ads in the ad repository 126 and select certain ads for display with their content.

The user access devices 108 can include devices capable of receiving information from the network 110. The user access devices 108 can include general computing components and/or embedded systems optimized with specific components for performing specific tasks. Examples of user access devices 108 can include personal computers (e.g., desktop computers), mobile computing devices, cell phones, smart phones, media players/recorders, music players, game consoles, media centers, media players, electronic tablets, personal digital assistants (PDAs), television systems, audio systems, radio systems, removable storage devices, navigation systems, set top boxes, and other electronic devices. The user access devices 108 can also include various other elements, such as processes running on various machines. In some implementations, the user access devices are not electronic (e.g., printed publications).

The network 110 can include any element or system that facilitates communications among and between various network nodes, such as elements 108, 112, 114, and 116. The network 110 can include one or more telecommunications networks, such as computer networks, telephone or other communications networks, the internet, etc. The network 110 can include a shared, public, or private data network (e.g., an intranet, a peer-to-peer network, a private network, a virtual private network (VPN), etc.) encompassing a wide area (e.g., WAN) or local area (e.g., LAN). In some implementations, the network 110 can facilitate data exchange by way of packet switching using the Internet Protocol (IP). The network 110 can also facilitate wired and/or wireless connectivity and communication.

In some implementations, user access devices 108 and advertisers 102 can provide usage information to the CMS 106 (e.g., whether or not a conversion or click-through related to an ad has occurred). This usage information can include measured or observed user behavior related to served content. For example, the CMS 106 can perform financial transactions, such as crediting publishers 104 and charging advertisers 102 based on the usage information.

In some implementations, a publisher can be a search service. A search service can receive queries for search results. In response, the search service can retrieve relevant search results from an index of documents (e.g., from an index of web pages). An exemplary search service is described in the article S. Brin and L. Page, “The Anatomy of a Large-Scale Hypertextual Search Engine,” Seventh International World Wide Web Conference, Brisbane, Australia, and in U.S. Pat. No. 6,285,999, both of which are incorporated herein by reference each in their entirety. For example, search results can include lists of web page titles, snippets of text extracted from those web pages, and hypertext links to those web pages, and can be grouped into a predetermined number of search results.

For example, a publisher (e.g., one of the publishers 104) can receive a search query request from a user access device (e.g., user access device 108a). In response, the publisher can retrieve relevant search results for the query from an index of documents (e.g., an index of web pages, which can be included in a content repository 124). The publisher can also submit a request for ads to the CMS 106. The ad request can include the desired number of ads. The number of requested ads can, for example, depend on the search results, the amount of screen or page space occupied by the search results, the size and shape of the requested ads, etc. The ad request can also include the search query (as entered or parsed), information based on the query (e.g., geo-location information, whether the query came from an affiliate and an identifier of such an affiliate, etc.), and/or information associated with, or based on, the search results. For example, the information can include identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from dot products of feature vectors corresponding to a search query and document, page rank scores, and/or combinations of IR scores and page rank scores, etc.

A user access device (e.g., user access device 108a) can present in a viewer (e.g., a browser or other content display system) the search results integrated with one or more of the ads provided by the CMS 106. In some implementations, the user access device can transmit information about the ads back to the CMS 106, including information describing how, when, and/or where the ads are to be/were rendered/presented (e.g., in HTML or JavaScript®).

In some implementations, a publisher can be a general content provider. For example, a publisher (e.g., one of the publishers 104) can receive a request for content from a user access device (e.g., user access devices 108a). In response, the publisher can retrieve the requested content (e.g., access the requested content from the content repository 124) and provide or present the content to the user access device 108a. The publisher can also submit a request for ads to the CMS 106. The ad request can include the desired number of ads. The ad request can also include content request information. This information can include, for example, the content itself (e.g., the web page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc. In response to the ads request, the CMS 106 can retrieve the requested ads (e.g., access the requested ads from the ad repository 126) and provide or present the ads to the requesting publisher.

A user access device (e.g., user access device 108a) can present in a viewer (e.g., a browser or other content display system) the content integrated with one or more of the ads provided by the CMS 106. In some implementations, the user access device can transmit information about the ads back to the CMS 106, including information describing how, when, and/or where the ads are to be/were rendered (e.g., in HTML or JavaScript®).

For purposes of explanation only, certain aspects of this disclosure are described with reference to the discrete elements illustrated in FIG. 1. The number, identity and arrangement of elements in the system 100 are not limited to what is shown. For example, the system 100 can include any number of geographically-dispersed advertisers 102, publishers 104 and/or user access devices 108, which can be discrete, integrated modules or distributed systems. Similarly, the system 100 is not limited to a single CMS 106 and can include any number of integrated or distributed CMS systems or elements.

Furthermore, additional and/or different elements not shown can be contained in or coupled to the elements shown in FIG. 1, and/or certain illustrated elements can be absent. In some examples, the functions provided by the illustrated elements could be performed by less than the illustrated number of components or even by a single element. The illustrated elements could be implemented as individual processes run on separate machines or a single process running on a single machine.

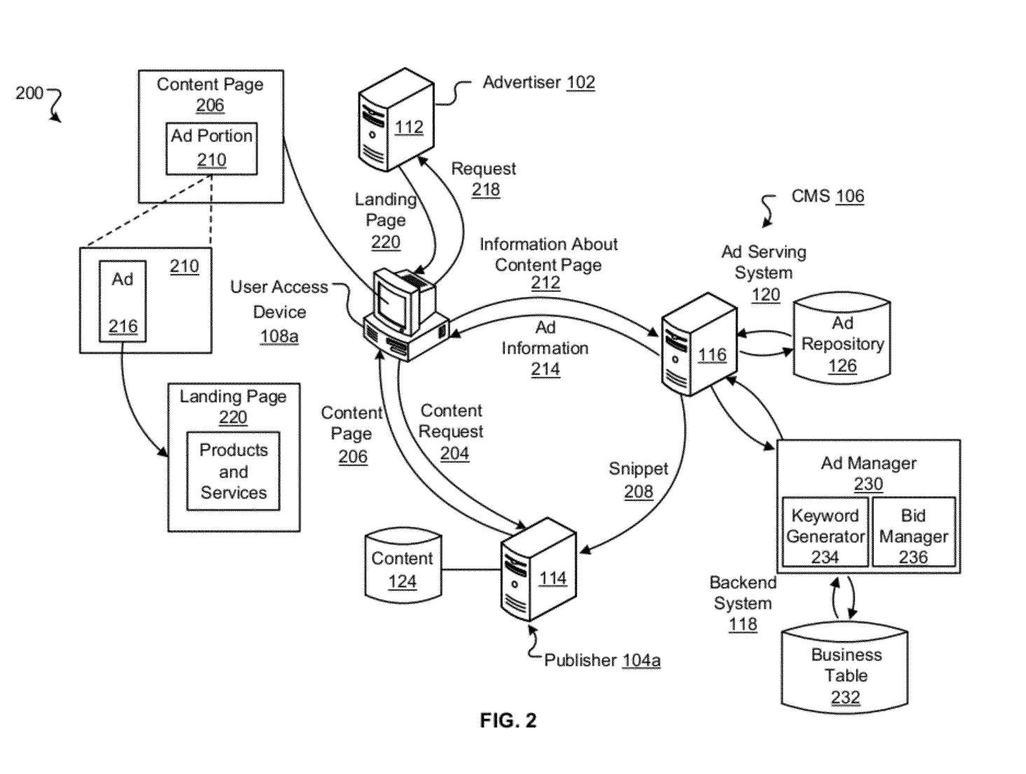

FIG. 2 is a data flow diagram showing an example data flow 200. In particular, the data flow 200 shows ad component interactions when ads are being served (e.g., by the advertising system 100). It should be noted that the data flow 200 is merely an example illustration and not intended to be restrictive. Other data flows are possible, and the illustrated events and their particular order in time can vary depending on a specific design and application.

As shown in FIG. 2, a publisher 104a can receive a content request 204 from the user access device 108a. For example, the content request 204 can be a request for a web document on a given topic (e.g., pet food suppliers). In response to the request 204, the publisher can retrieve relevant content (e.g., the web page for ExamplePetSupplyRetailer) from the content repository 124.

The publisher 104a can respond to the content request 204 by sending a content page 206 or other presentation, representation, or characterization of the content to the requesting user access device 108a. The content page 206 can include the requested content (e.g., the web page for ExamplePetSupplyRetailer) as well as a code snippet 208 associated with an ad. For example, a code snippet can refer to a method used by one device (e.g., a server) to ask another device (e.g., a browser running on a client device) to perform actions after or while downloading information. In some implementations, a code snippet can be in JavaScript® code or can be part of the HTML or other web page markup language or content.

In some implementations, the CMS 106 can send the code snippet 208 to the publisher 104a and/or the user access device 108a. In some implementations, the code snippet 208 can originate and/or be provided from other sources. As the requesting user access device 108a loads the content page 206, the code snippet 208 causes the user access device 108a to contact the CMS 106 and receive additional code (e.g., Java Script®), which causes the content page 206 to load with an ad portion 210.

The ad portion 210 can be similar to, or include, an ad block. The ad portion 210 can include any element that allows embedding/including of information within the content page 206. In some implementations, the ad portion 210 can be an HTML element (e.g., an I-Frame) or other type of frame.

In some implementations, the ad portion 210 can be hosted by the CMS 106 or the publisher 104a and can allow content (e.g., ads) from the CMS 106 or the publisher 104a to be embedded inside the content page 206. Parameters associated with the ad portion 210 (e.g., its size, shape, and other style characteristics) can be specified in the content page 206 (e.g., in HTML), so that the user access device 108a can present the content page 206 while the ad portion 210 is being loaded.

In general, when a user clicks on or otherwise interacts with the displayed ad 216, an embedded code snippet can direct the user access device 108a to contact the CMS 106. During this event, the user access device 108a can receive an information parcel, such as a signed browser cookie, from the CMS 106. This information parcel can include information, such as an identifier of the selected ad 216, an identifier of the publisher 104a, and the date/time the ad 216 was selected by the user. The information parcel can facilitate processing of conversion activities or other user transactions.

The user access device 108a can then be redirected to the advertiser 102 associated with the selected ad 216. The user access device 108a can send a request 218 to the associated advertiser 102 and then load a landing page 220 from the advertiser 102. The user can then, for example, perform a conversion action at the landing page 220, such as purchasing a product or service, registering, joining a mailing list, etc. The CMS 106 can provide a code snippet, which can be included within a conversion confirmation page script such as a script within a web page presented after the purchase. The user access device 108a can execute the code snippet, which can contact the CMS 106 and report conversion data to the CMS 106. The conversion data can include conversion types and numbers as well as information from cookies. The conversion data can be maintained in a conversion data repository.

As shown in FIG. 2, the backend system 118, in some implementations, can include an ad manager 230 and a business table 232. The business table 232 can store, for example, user information, user account information including billing information, campaign related information and advertisement data associated with one or more business advertisers as well as geo-targeting information (to be discussed in greater detail below). Based on the information stored in the business table 232, the ad manager 230 can tailor a specific online advertising campaign on behalf of a local business advertiser. In some implementations, the ad manager 230 can be a backend application that can continuously scan the business table 232 for updated information. Where new or updated information is found, the ad manager 230 can initiate campaign management updates to the one or more business ad listings associated with the local business advertiser.

In some implementations, the business advertisers can include local businesses, nation-wide or global businesses, affiliates, or any appropriate business entity (hereinafter “local business advertiser”). A local business advertiser can, using the ad serving system 120, create a local business ad listing tailored for a specific geographic region (e.g., a domestic region local to the business of the local business advertiser). A local business ad listing can be shown where a search query contains geographic data. Local business ad listings that are not targeted to the geographic area specified in the search query can be precluded from being shown as a search result to the search query.

The ad manager 230 can facilitate the account management and advertising campaign for each local business owner or advertiser. The ad manager 230 can furnish a user interface through which online campaigns can be created based on a local business's needs and characteristics. For example, ad manager 230 can identify related keywords (e.g., using keyword generator 234) upon receipt/identification of local business characteristics for a given local business. A keyword can be any word, string, token, phrase, or set of words, strings, tokens, or linguistic constructs that can be searched upon using any search query. A keyword also can refer to non-linguistic constructs, such as a partial image that can be used in an image search, or a word, a set of words, or phrase that is used by a consumer to search for a specific business, product or service. In some implementations, the keywords can be identified by the backend system 118 in real-time as local business information is received. The keywords can be generated in a background not visible to the local business advertiser.

A local business advertiser can create an advertising campaign by submitting campaign configuration data to the ad serving system 120, which can be stored in the business table 232. In some implementations, the campaign configuration data can include information such as, without limitation, campaign name, campaign settings, keywords, keyword settings (e.g., bid range, match type, target rank, etc.), negative keywords, ads, ad groups, targeting, budget and other parameters. Based on the campaign configuration data, the ad manager 230 can recommend or automatically implement edits to the campaign including recommending keywords, recommending negative keywords, suggesting targeting, creating ad groups, reorganizing ad groups, disabling ineffective ads, disabling ineffective keywords, and other edits.

For example, a local business advertiser can submit a local business name, address, phone number and business category information to the ad serving system 120. The local business advertiser can choose to advertise a business ad listing locally. When this option is elected, the ad manager 230 can present to the local business advertiser an optional request to manage the business ad listing on behalf of the local business advertiser including setting and maintaining a budget for the business ad listing that can be used for managing auction bids. In some implementations, the budget can be a daily budget. In some implementations, the budget can be a monthly budget. As listings are submitted, the ad manager 230 can manage bids to ensure the budget does not exceed the budget allowed by the local business advertiser.

Conventional interfaces allow advertisers to choose a variety of bidding models and to select to pay by the number of impressions (CPM bidding), by the number of clicks on an ad (CPC), or by the number of conversions generated in response to an ad (e.g., with Javascript code embedded at a purchasing site associated with the advertiser). After selecting the bidding model, the advertiser can choose to target keywords for the advertisement placements by entering, directly into the conventional interface, one or more keywords for targeting. For example, a bicycle company may target an outdoors magazine, but may want its ads displayed only to users who search on keywords such as “bike,” “cycle,” “mountain,” and “trails,” or displayed only on pages within the site that contain such keywords.

However, local business owners may not be familiar with the concept of keyword auctions or find keyword auctions sufficiently effective to justify an advertising investment. This is especially true in small businesses, in which a typical owner tends to be reactive rather than proactive for any business-related advertising strategies. Furthermore, the existing auction format for online advertisement is often too cumbersome and time-consuming to be appealing to the local business owners. For local business owners, the print media traditionally has been more convenient in terms of placing advertisements. To reduce the constraints and burden on the local business owners to learn how to properly set a competitive online advertising campaign using appropriate keywords, in some implementations, the keyword generator 234 can generate keywords automatically on behalf of the local business advertiser (e.g., without user intervention) by using the business ad listing information or campaign configuration data stored in the business table 232 such as business description, reviews, and commonly associated user queries. In some implementations, the ad manager 230 can evaluate the advertising information stored in the business table 232, and generate a number of keywords and/or key phrases to represent the business category corresponding to a business ad listing. The keyword generator 234 also can generate and output a ranking of the top keywords with a weight value according to one or more automatic weight schemes. The keywords can be weighted according to other information processed from the other content types, such as embedded links, advertisements, and images.

In some implementations, the keywords can be dynamically managed as more information is received on the listing performance. For example, the keyword generator 234 can consider clicks to an ad listing, clicks to the website of the local business and clicks to reviews to determine the relevancy and performance of the keywords generated by the keyword generator 234. If the performance shows a particular keyword is underperformed (e.g., not garnering enough clicks or visits to the business's website), then the ad manager 230 can replace the existing keyword(s) with new keyword(s) automatically without any manual action from the local business advertiser. In evaluating the performance of a selected keyword, the ad manager 230 can examine, for example, the online traffic to the business's website, the number of impressions associated with the business ad listing (e.g., the number of times the business ad listing was presented to users), the number of clicks (e.g., the number of times the business ad listing has been clicked on), or other available information.

In some implementations, keywords can be generated offline using local search data about a business. For example, the ad manager 230 can retrieve (e.g., from the business table 232) and utilize the business category or categories specified by the local business advertiser during ad creation as a source for keyword generation. Other sources for keyword generation can include, without limitation, business websites, web references, business description, products and services listed in other similar business ad listings. Although the keyword generation can be performed by the ad manager 230, in some implementations, the keyword generation can be performed by an external web service, application programming interface (API), or other service.

Based on the listing information, the keyword generator 234 can determine and generate a definition of a service area for a local business online advertiser. Specifically, the ad manager 230 can retrieve location information associated with a business as well as other relevant service area data, and process this information to create or determine a service area.

For example, the ad manager 230 can receive a business address or geographic location and other service area defining data, such as business type, business size, maximum drive time, transportation mode(s), geographical features, locality type (e.g., urban, suburban, rural, or the like) from the listing information, and generate a matching service area based on this information that defines or relates to the local business's service area. The keyword generator 234 can generate a set of keywords as described above. In some implementations, the keyword generator 234 can generate the set of keywords based at least in part on the defined or received service area, and return geographic keywords or geo-keywords such as the names of neighborhoods that overlap the service area, area codes within the service area, parks nearby the business, landmarks in the service area, and other geographic or spatial attributes that better textually define the service area for a business (e.g., search terms that are often used by online searchers when trying to define a locality that is associated with the local business's service area). The keyword generation can be generated as a background application, making integration into campaign management platforms relatively transparent and simple for the user.

The keywords returned by the keyword generator 234 can take many forms for defining a local business service area. For example, the keywords returned can include terms or phrases pertaining to, without limitations, neighborhoods, area codes, parks, rail systems/stations, postal codes, landmarks, hospitals, mass transit systems/stations, administrative boundaries, museums, airports, schools/universities, political/governmental boundaries (e.g., city boundaries, county boundaries, state boundaries, country boundaries, and the like), geographic features, bus stations, cultural attractions, countries; post offices, or other location references. For example, a local business advertiser can provide service area defining data to the ad manager that includes an address or location of a business (e.g., 500 Arguello St, Redwood City, Calif.) along with information useful for defining a business category (e.g., a law firm). The ad manager 230 can use the business category to retrieve a default service area size (e.g., a few blocks up to 1 mile or more in radius or defining region), and generate a service area definition by creating a shaped (e.g., circular) area about or including the center point/location at the business address. The business table 232, which can store geographically-based data (e.g., data/keywords for the classes listed above) in addition to business ad listing information, can be parsed, searched or accessed with the service area definition to generate a listing of or set of geo-keywords for the service area. In the above example, the keyword set returned can include Redwood Shore (e.g., a matching neighborhood), Redwood City Kiwanis Farmers Market (e.g., a matching cultural attraction); Sequoia Hospital (e.g., a matching hospital), or other area descriptors.

In some implementations, each business category also can be seeded with one or more high confidence keywords, and the one or more high confidence keywords can be compiled into a seed keyword list. In some implementations, the high confidence keywords can be extracted based on local search queries (e.g., performed by other advertisers, publishers or users). If a business category is not already part of the local search query, the category name can be used as a high confidence keyword. In some implementations, each high confidence keyword can be expanded to identify other related or relevant keywords. All of the keywords, including the expanded ones, can be compared, and an identification can be performed to determine keywords that are of important value to a particular local business ad listing. The identified keywords can then be added to the seed keyword list. Each business category can be reviewed, expanded, and prioritized based on, for example, the number of business ad listings under the respective business category and business revenue. Queries that lead to interactions (e.g., clicks on) with business ads also can be considered in generating the seed keyword list.

As discussed above, the ad manager 230 can create online campaigns based on local business's business characteristics, and generate business-specific keywords using a variety of sources including, for examples, product or service description provided by the local business advertiser, business website, prominent web references to the listing, structured data about the business in local search index, user reviews, business category and the like. For example, during the initial signup, the ad manager 230 can present several business categories under which ads can be shown. A local business owner can check or uncheck any category under which an ad is or is not to be presented. Once these categories have been identified, the ad manager 230 can generate one or more business-specific keywords based on the selected (or non-selected) categories. For example, the ad manager 230 can present a list of business categories including restaurant, bars & pubs, liquor stores, caterers, or other categories, and the local business advertiser can select one or more of the presented categories for the business ad to be created. If the local business advertiser selects “Restaurant”, the ad manager 230 can automatically associate the business ad listing with keywords such as culinary, recipes, food, or menus. Alternatively, the ad manager 230 can generate, in advance, a listing of business-specific keywords, and from the identified categories, remove irrelevant keywords that do not fall under the selected category or categories.

In some implementations, the ad manager 230 also can automatically manage the bids and spending on behalf of the local business advertiser. For example, upon receiving a specific budget from the local business advertiser, the ad manager 230 can automatically manage bids and spending (e.g., using bid manager 236) for an advertising campaign based on the allotted budget. The ad manager 230 can set up and manage an online local advertising campaign on behalf of the local business advertiser, thus removing the need for any technical expertise and time that most local advertisers might not possess or afford.

The bid manager 236 can receive, retrieve, or otherwise obtain or acquire advertising data. Advertising data can include data received from a local business advertiser such as, but not limited to, keywords, bids, utility values and constraints (e.g., min/max bids, campaign budget and the like). This data can be input by the local business advertiser via a graphical user interface (GUI). Additionally or alternatively, a wizard can be employed to capture advertising data from the local business advertiser by way of a series of sequential graphical interfaces windows. The bid manager 236 also can obtain advertising data such as current bids and price per slot for various keywords, number of searches for keywords, and click through rate (CTR), among other things.

The bid manager 236 can be used to optimize advertising bids within a campaign. The bid manager 236 can receive data including advertisement campaign data such as keywords and one or more budget constraints from the business table 232, and maximize the total utility while minimizing the total spending or bids for an ad campaign. The bid manager 236 can determine or estimate the price, on behalf of the local business owner, for each keyword/slot pair and automatically adjust provided bids or generate new bids in order to purchase a cost effective slot. In some implementations, the bid manager 236 also can decrease bids on keywords that have low return so that the budget is not exhausted early and more can be spent on high return words.

In some implementations, the bid manager 236 can generate statistics of each keyword generated by the keyword generator 234. From the statistics, the bid manager 236 can identify the marginal profit or return on investment (ROI) associated with each keyword or ad. For example, the ROI can correspond to the number of sales or acquisitions generated for particular keywords. The bid manager 236 can modify bids or generate new effective bids for each keyword or ad. For example, if the ROI for one keyword is less than the ROI for another keyword, then the bid manager 236 can increase the bid on the keyword with a higher ROI and decrease the bid on the keyword with a lower ROI, thereby optimizing bids and spending on keywords that are of higher value to the local business advertiser without exhausting the budget specified by the local business advertiser.

In some implementations, the bid manager 236 can maximize a local business advertiser's total return by equalizing the ROI of the advertiser for each keyword. Where initial bids are provided, the bid manager 236 can move a keyword to a slot higher or a slot lower to optimize ROI. To accomplish this objective, the bid manager 236 can increase or decrease the bids on keywords. For example, the bid manager 236 can select a keyword with the maximum ROI, or pick the keyword for which the slot above it has the highest ROI. As another example, to choose a keyword that is to be moved down, the bid manager 236 can select the one with the lowest ROI or the one for which the slot that is to be moved to has the lower ROI. In brief, the bid manager 236 can move up a keyword if the budget is currently being under spent, or move down the keyword if the budget is currently being overspent, as can be determined utilizing statistics about the number of times each keyword becomes available. In an event that such statistics are not available, the bid manager 236 can generate or infer heuristically the required values, for example from past data (e.g., learned data). In some implementations, the bid manager 236 can continue to increase bids for all keywords until the budget has been exhausted, or decrease bids for one or more keywords if the budget is spent too early. In sum, the foregoing approach allows the bid manager 236 to quickly locate the optimal allocation for bidding as well as in spending on behalf of the local business advertiser.

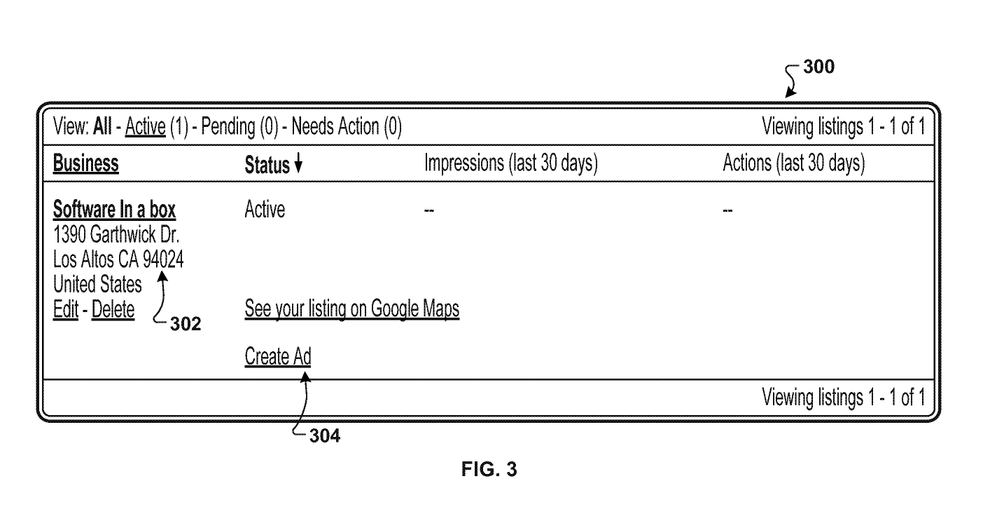

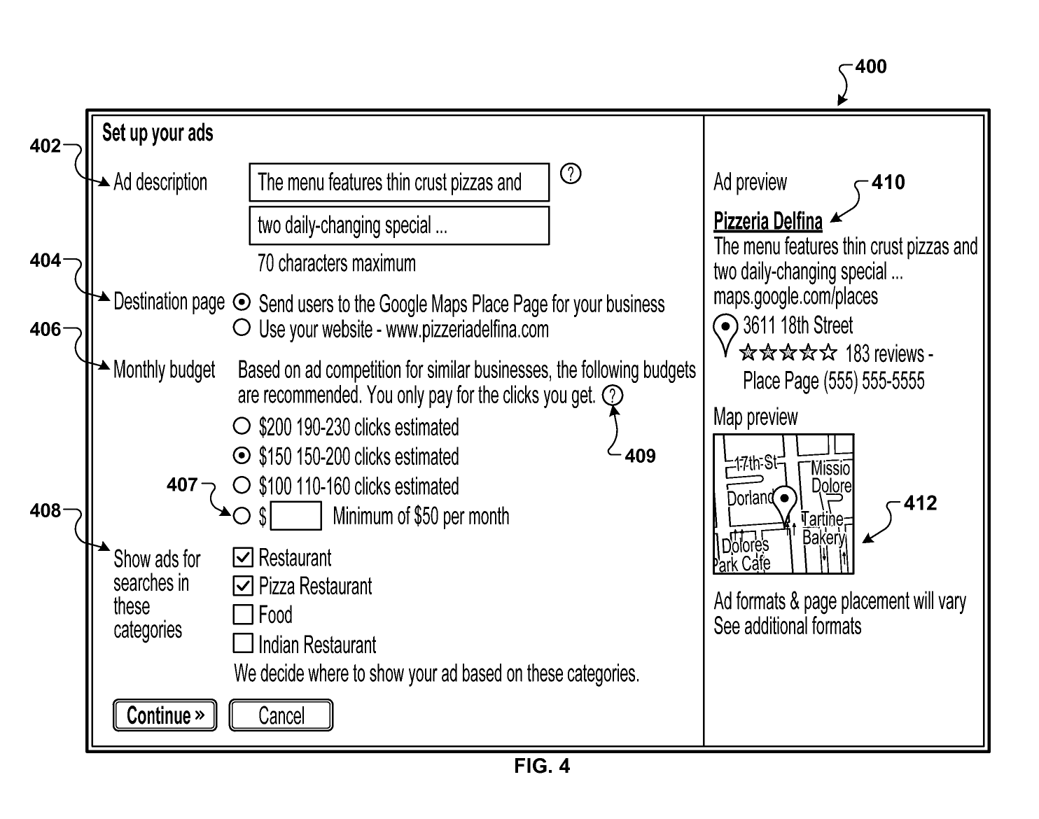

FIG. 3 shows an example of a business ad listing interface 300 displaying a business ad listing page from which a business ad can be created. In some implementations, the business ad listing interface 300 can be generated by the ad manager 230, and pre-populated with information 302 of a business of the local business advertiser upon login. The pre-populated information 302 can be retrieved from the business table 232. In some implementations, the business ad listing interface 300 can be tailored for use in a local business advertising campaign, and the pre-populated information 302 displayed in the business ad listing interface 300 can be retrieved from other existing advertising online campaigns hosted by the CMS 106. A local business advertiser, upon authentication, can be presented with an option to create a local advertising campaign through the “Create Ad” option 304. FIG. 4 shows an example of a setup interface 400 through which a local business online campaign can be created.

Referring to FIG. 4, the setup interface 400 can include an ad description field 402, a destination page field 404, a budget field 406, a category field 408, and an ad review section 410.

The ad description field 402 can be populated with a variety of information relating to the type of business of the local business advertiser such as the type of food advertised, the particular product sold, or the specific service rendered. In the example shown, the ad description field 402 can be populated with information relating to the special of the day, such as “thin crust pizzas and two daily-changing special”. In cases where the local business advertiser has an existing national online campaign hosted by the CMS 106, the setup interface 400 can extract the business description, and populate the extracted information into the ad description field 402. Information populated in the ad description field 402 can be stored in the business table 232.

In the destination field 404, the local business advertiser can designate the landing page when a user interacts with the advertisement that is to be created. For example, the local business advertiser can request the CMS 106 to send the users to a mapping page showing the location of the business in a map. Alternatively, the local business advertiser can request the CMS 106 to send the users to the business web site. In some implementations, the advertising expenses that the local business advertiser may be charged can depend on where the local business advertiser designates as the landing page. A conversion can occur when a user consummates a transaction related to a previously served advertisement. What constitutes a conversion may vary from case to case and can be determined in a variety of ways. For example, an online conversion may occur when a user clicks on an advertisement, is referred to the advertiser's web page, and consummates a purchase on the advertiser's web page before leaving that web page. A conversion can also be defined by an advertiser to be any measurable/observable user action such as, for example, downloading a white paper, navigating to at least a given depth of a web site, viewing at least a certain number of web pages, spending at least a predetermined amount of time on a web site or web page, or registering on a web site. Other actions that constitute a conversion can also be used.

In the budget field 406, the setup interface 400, in some implementations, can populate one or more budget options that have been determined as appropriate for the local business advertiser's online campaign based on competition for similar businesses. For example, the budget field 406 can display three predetermined budget options such as “$200”, “$150”, and “$100”. Optionally, the budget field 406 can furnish an estimate of the number of ad conversions that will likely occur for a given budget spend. The number of ad conversions can be the number of times that an ad impression led to a sale (e.g., at a website hyperlinked to the ad) based on the click-through rate (CTR), or the cost per click through rate (CPC). For a given ad (or group of ads), the CTR can be the number of click throughs divided by the number of impressions, and the CPC can be the number of click throughs divided by the total amount spent for the ad. In the example shown, based on click-through statistics gathered by the CMS 106, the budget field 406 can display to the local business advertiser an estimate of “190-230 clicks” for a “$200” budget, an estimate of “150-200 clicks” for a “$150” budget, and an estimate of “110-160 clicks” for a “$100” budget.

In some implementations, the budget field 406 also can present a user-defined option 407 under which the local business advertiser can specify a personal budget that is outside the suggested budget range. When the user-defined option 407 is selected, the setup interface 400 can populate the minimum budget amount required to activate this option. For example, the setup interface 400 can display a minimum of $50 per month under the user-defined option 407.

In some implementations, the user-defined option 407 can be configured to allow the advertiser to specify a maximum monetary value (as opposed to a minimum value) the advertiser is willing to pay for a click or impression. The advertiser can choose the user-defined option 407 to allow the bid manager 236 to control each bid or make frequent bid adjustments within the maximum budget allowed. In some implementations, the user-defined option 407 also can be configured to allow the advertiser to set a 30-day budget and to allow the bid manager 236 to manage bids within the 30-day period to obtain the most clicks on behalf of the advertiser. In some implementations, the user-defined option 407 also can be configured to allow the advertiser to set a target bid (e.g., CPA target) for each of the advertiser's keywords/ad groups. In some implementations, the advertiser can choose the user-defined option 407 to automatically request the bid manager 236 to get the most conversions on behalf of the advertiser for the advertiser's target bid and to implement automated value-based bidding. In some implementations, the user-defined option 407 also can be configured to allow the advertiser to set a conversion-based bid. The advertiser can use the user-defined option 407 to pay only for sales, thereby being able to compare the advertisement cost directly to a sale.

Although the setup interface 400 allows for a budget to be presented and a CTR target displayed, other target metrics are possible, such as Return-On-Advertising Spend (ROAS), Return-On-Investment (ROI) and any other appropriate metrics.

The category field 408 can specify one or more business categories under which the ad to be created can be classified. For example, the category field 408 can display four categories including “Restaurant”, “Pizza Restaurant”, “Food” and “Indian Restaurant”. In some implementations, the categories displayed under the category field 408 can be automatically generated based on the information provided by the business ad listing interface 300. For example, if the business ad listing information shows that the business is a “Violin Makers”, then the setup interface 400 can automatically display “Violin Shop” and “Violin Dealer” as two of the categories displayed to the local business advertiser. Once the category or categories have been selected, the ad to be created can be shown under the selected category or categories.

The ad review section 410 can be utilized to show an advertiser how a particular advertisement listing may appear when the ad listing becomes active. If the ad listing does not display correctly in the ad review section 410, the local business advertiser can change the ad listing until the ad listing is suitable for display. The ad listing shown in the ad review section 410 can include all or only a subset of the fields entered by the advertiser. For example, the ad listing can include the business name (e.g., “Pizzeria Delfina”) and description (e.g., “The menu features thin crust pizzas and two daily-changing special”), the destination page (e.g., “maps.google.com/places), the phone number (e.g., “(555)555-5555”), reviews (e.g., “183 reviews”), and street address (e.g., “3611 18^{th} Street”). The ad review section 410 also can display other information not shown in FIG. 4 such as, without limitation, email address, contact name, business description or type, locality or neighborhood information, and the like. The ad listing shown in the ad review section 410 can include a subset of the fields entered, or omit certain fields, such as reviews. The ad review section 410 also can include a map review 412 showing the location of the business in a map to allow users/viewers to identify the surrounding neighborhoods or establishments closest to the business.

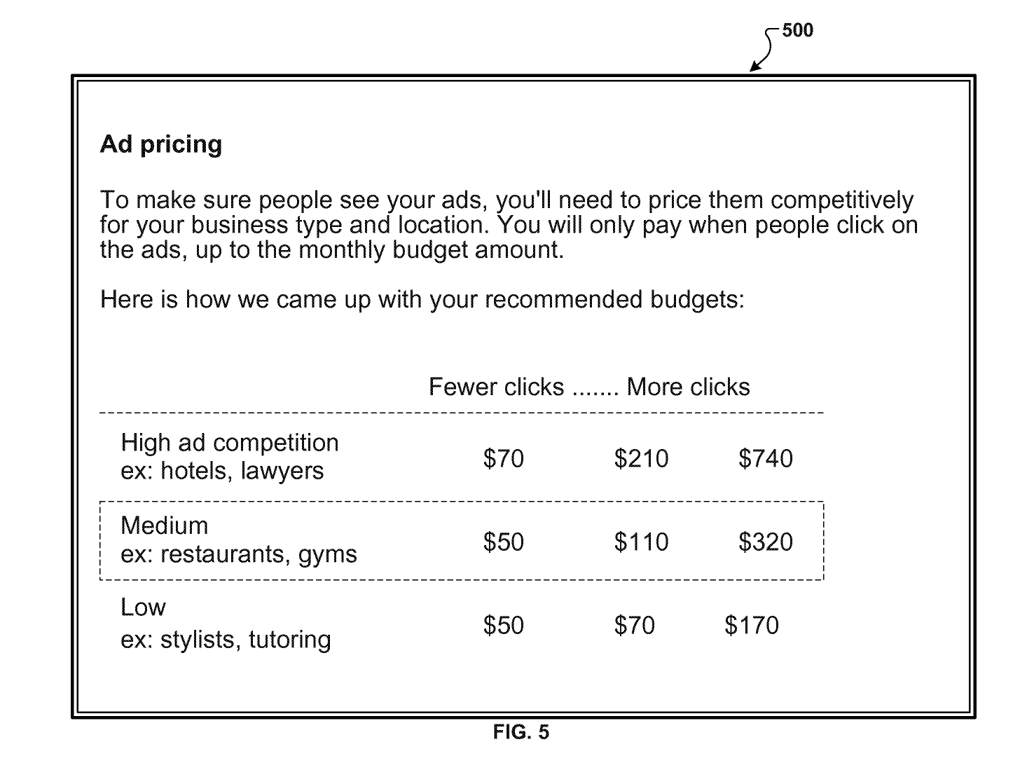

As discussed previously, the setup interface 400 can include a budget field 406 where the local business advertiser can identify a desired budget appropriate for the local business advertiser's online campaign based on competition for similar businesses. FIG. 5 shows an example of a budget recommendation chart 500 from which the local business advertiser can reference one of several bidding and spending management options.

FIG. 5 shows an example of a budget recommendation chart 500 that displays one or more spending options based on the budget previously specified in the budget field 406 shown in FIG. 4. In some implementations, the budget recommendation chart 500 can be populated by clicking on the icon 409.

In the example shown in FIG. 5, the budget recommendation chart 500 can present a range of prices and the corresponding estimated number of clicks to the local business advertiser. In the example shown, the budget recommendation chart 500 can display three competitive ad categories including “High”, “Medium” and “Low”. In some implementations, each category can be defined based on the business being advertised. For example, an ad listing falling under the “Hotels” or “Lawyers” category can be classified under the “High ad competition” category. As another example, an ad listing falling under the “Restaurants” or “Gyms” category can be classified under the “Medium” category. As yet another example, an ad listing falling under the “Stylists” or “Tutoring” category can be classified under the “Low” category.

For each category, a range of spending spanning from “Fewer clicks” to “More clicks” can be presented to the local business advertiser as a recommendation. For example, under the “High ad competition” category, the budget recommendation chart 500 can suggest a spending of “$70” if a local business advertiser desires only few clicks to the ad listing, or “$740” if the local business advertiser desires a maximum number of clicks to the advertiser's web site. An intermediate option of “$210” also can be suggested if the local business advertiser desires more than a minimal number of clicks without exhausting all of the advertising budget. As another example, under the “Medium” category, the budget recommendation chart 500 can suggest a spending of “$50” if a local business advertiser desires only few clicks to the ad listing, or “$320” if the local business advertiser desires a maximum number of clicks to the advertiser's ad. Similar to the “High ad competition” category, an intermediate option of “$110” also can be suggested if the local business advertiser desires an average number of clicks without exhausting all of the specified budget. Similarly, under the “Low” category, the budget recommendation chart 500 can suggest a spending of “$50” if a local business advertiser desires only few clicks to the ad listing, or “$170” if the local business advertiser desires a maximum number of clicks to the advertiser's ad. Similar to the “High ad competition” category and the “Medium” category, an intermediate option of “$70” also can be suggested if the local business advertiser desires an average number of clicks.

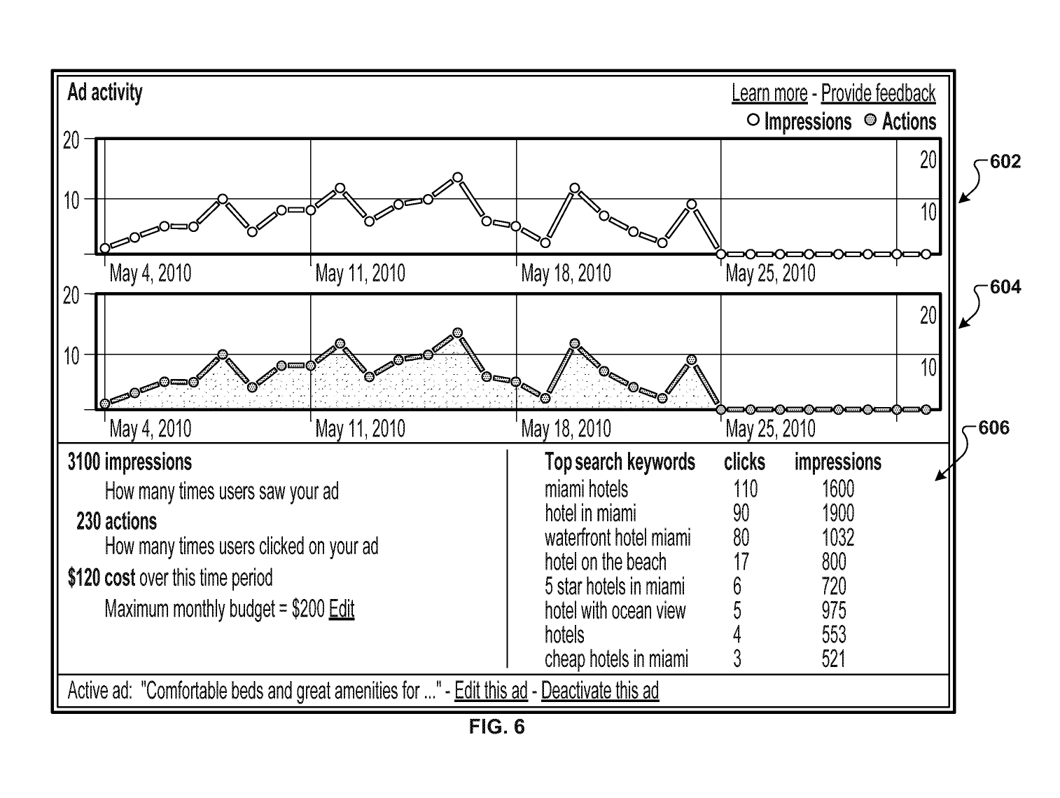

FIG. 6 shows an example of a statistics page 600 that can be presented to the local business advertiser after the local business ad listing has been created. In some implementations, the statistics page 600 can provide statistical data about views, keywords, and when searchers request directions to the business's web site. In some implementations, a subset of the statistics shown in the statistics page 600 can be presented on the business ad listing interface 300 once the business ad listing is activated and published. The statistics page 600 can be retrieved when the local business advertiser selects the business ad listing (e.g., by clicking on the business name).

The statistics page 600 can illustrate a variety of graphs and analytics to assist the local business advertiser understand who the viewership is and what the viewers are looking for. The local business advertiser can customize the graphs and analytics by selecting a specific time span (e.g., last 7 days, last 30 days, a particular single day, etc.).

The statistics page 600 can reconfigure the activity graphs based on the selected time span, and display the amount of traffic within the interval length chosen. Customizing the time span allows the local business advertiser to determine the traffic trend in the amount of visitors over a period of time in order to gauge whether a particular business ad listing is working effectively at attracting viewers or further adjustments to the business ad listing are needed.

In the example shown, an “impression” graph 602 and an “action” graph 604 can be presented to the local business advertiser. Impression refers to the number of times a visitor to the business ad listing saw the business ad listing as a result of a local search, whereas action refers to the number of times a visitor interacted with (e.g., clicked on) the business ad listing (e.g., opening “More Info” on the map, requesting “Driving Directions” to the location of the business being advertised, and clicking the embedded web site link).

The statistics page 600 also can display a section 606 showing the keywords (and corresponding number of clicks and impressions) generated by the keyword generator 234 and used by users/viewers to locate the business ad listing. For example, the keywords “miami hotels” has garnered “110” clicks and “1600” impressions. As another example, the keywords “hotel in miami” has garnered “90” clicks and “1900” impressions.

As discussed above, the ad manger 230 can automatically select one or more keywords on behalf of the local business advertiser (e.g., from statistics shown in similar businesses) to maximize the number of clicks and impressions of the business ad listing. In the example above, the keyword generator 234 can, upon receiving ad listing information associated with the local ad (e.g., during the initial signup phase), generate keywords such as “Miami hotels”, “hotel in miami”, “waterfront hotel miami”, “hotel on the beach”, “5 stars hotels in miami”, “hotel with ocean view”, “hotels”, and “cheap hotels in miami”. Because the keywords are automatically generated and selected for the local business advertiser based on, for example, local business information, there is no need to edit the business ad listing to tie the keywords to the top user interests.

As discussed previously, the bid manager 236 can be used to optimize advertising bids within a campaign. Based on statistics, the bid manager 236 can identify the marginal profit or return on investment (ROI) associated with each keyword or ad, and modify bids or generate new effective bids for each keyword or ad without exhausting the budget specified by the local business advertiser. For example, the bid manager 236 can receive data including ad campaign data such as local business information, keywords and one or more budget constraints from the business table 232, and maximize the total utility while minimizing the total spending or bids for an ad campaign specific to a particular local market. The bid manager 236 can determine or estimate the price, on behalf of the local business owner, for each keyword/slot pair and automatically adjust the bids or generate new bids in order to purchase a cost effective slot. The bid manager 236 also can decrease bids on keywords that have low return so that the budget is not exhausted early and more can be spent on high return words. In some implementations, the bid manager 236 can initialize the ad campaign with average bids for the relevant keywords from data gathered for businesses in a similar locality.

As described above, the ad manager 230 can maintain an ad campaign on behalf of the local business advertiser based on information obtained from various sources. Keywords can automatically be selected by programmatically analyzing search histories of users/viewers to identify the keyword strings most frequently used to locate the business's web site, web page, and/or business directory. The ad manager 230 also can provide the local business advertiser with additional information such as, without limitations, suggested bid amounts for particular keyword strings, as derived, for example, from historical bid activities of other advertisers/businesses that have used such keyword strings; a default geographic region to target, as derived, for example, from a business address included in an associated business directory listing; a suggested browse node or category to with which the ad is to be associated for purposes of selecting the ad for display; a default budget for the ad campaign; and payment information for paying for the ad campaign.

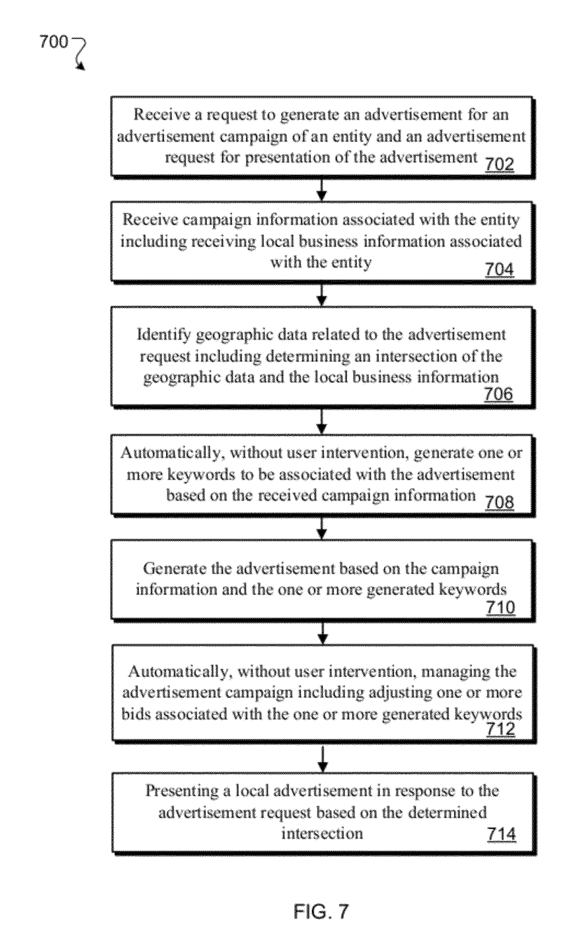

FIG. 7 shows an example of a process 700 for presenting content to a user. The process 700 can be performed, for example, by the CMS 106, and for clarity of presentation, the description that follows uses the CMS 106 as the basis of examples for describing the process 700. However, another system or combination of devices and systems also can be used to perform the process 700.

Referring to FIG. 7, at 702, a request to generate an advertisement for an advertisement campaign of an entity and an advertisement request for presentation of the advertisement can be received.

At 704, campaign information associated with the entity including receiving local business information associated with the entity can be received.

At 706, geographic data related to the advertisement request can be identified. In some implementations, an intersection of the geographic data and the local business information can be determined.

At 708, one or more keywords to be associated with the advertisement can be automatically, without user intervention, generated based on the received campaign information.

At 710, the advertisement can be generated based on the campaign information and the one or more generated keywords.

At 712, the advertisement campaign can be automatically, without user intervention, managed including adjusting one or more bids associated with the one or more generated keywords.

At 714, a local advertisement can be presented in response to the advertisement request based on the determined intersection

### Generic Computer System

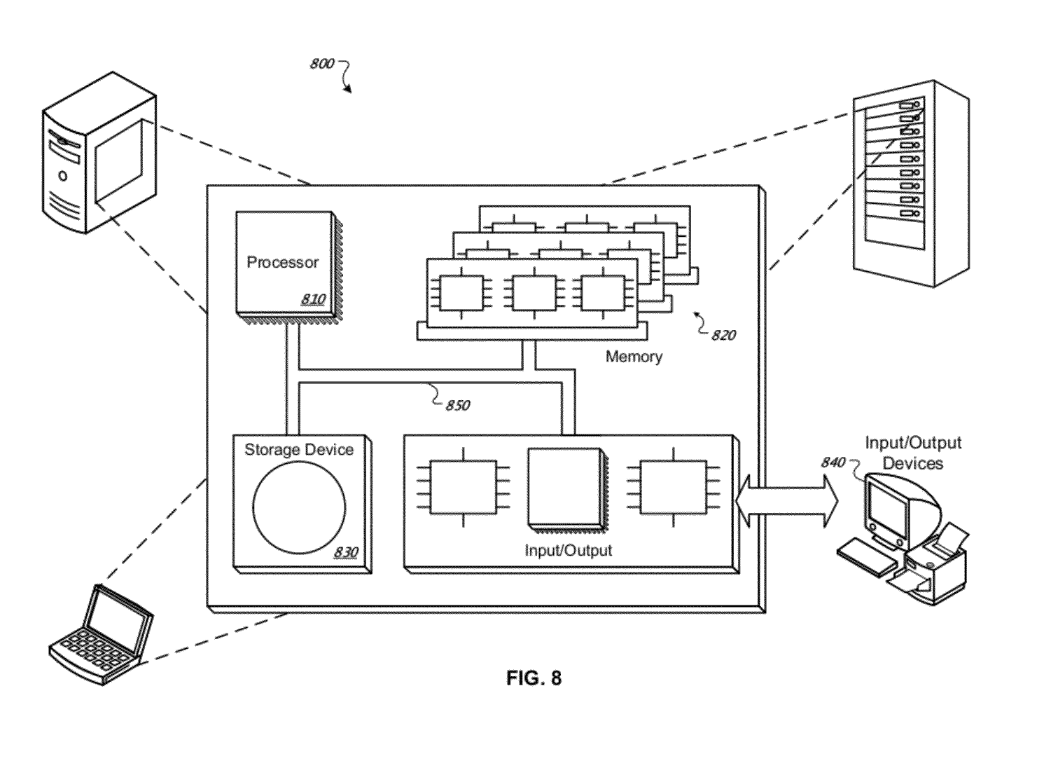

FIG. 8 is a block diagram of generic processing device that may be used to execute methods and processes disclosed. The system 800 may be used for the operations described in association with the method 300 according to one implementation. The system 800 may also be used for the operations described in association with the method 400 according to another implementation. For example, the system 800 may be included in either or all of the CMS 106, the publishers 104, and the advertisers 102.

The system 800 includes a processor 810, a memory 820, a storage device 830, and an input/output device 840. Each of the components 810, 820, 830, and 840 are interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In some implementations, the memory 820 is a computer-readable medium. In some implementations, the memory 820 is a volatile memory unit. In other implementations, the memory 820 is a non-volatile memory unit.

The storage device 830 is capable of providing mass storage for the system 800. In one implementation, the storage device 830 is a computer-readable medium. In various different implementations, the storage device 830 may be a floppy disk device, a hard disk device, an optical disk device, or a tape device. The storage device 830 may be used, for example, to store information in the content repository 124, and the ad repository 126.

The input/output device 840 provides input/output operations for the system 800. In one implementation, the input/output device 840 includes a keyboard and/or pointing device. In another implementation, the input/output device 840 includes a display unit for displaying graphical user interfaces.

A few implementations have been described in detail above, and various modifications are possible. The disclosed subject matter, including the functional operations described in this specification, can be implemented in electronic circuitry, computer hardware, firmware, software, or in combinations of them, such as the structural means disclosed in this specification and structural equivalents thereof, including potentially a program operable to cause one or more data processing apparatus to perform the operations described (such as a program encoded in a computer-readable medium, which can be a memory device, a storage device, a machine-readable storage substrate, or other physical, machine-readable medium, or a combination of one or more of them).

The features described may be implemented in digital electronic circuitry, or in computer hardware, firmware, software, or in combinations of them. In some implementations, the apparatus may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output. In other implementations, the apparatus may be implemented in a computer program product tangibly embodied in an information carrier, e.g., in a propagated signal, for execution by a programmable processor.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The term “system” encompasses all apparatus, devices, and machines for processing data, including by way of example a programmable processor, a computer, or multiple processors or computers. The system can include, in addition to hardware, code that creates an execution environment for the computer program in question, e.g., code that constitutes processor firmware, a protocol stack, a database management system, an operating system, or a combination of one or more of them.

A program (also known as a computer program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A program can be deployed to be executed on one computer or on multiple computers that are located at one site or distributed across multiple sites and interconnected by a communication network.

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

A number of embodiments of the invention have been described. Nevertheless, it will be understood that various modifications may be made without departing from the spirit and scope of the invention. Accordingly, other embodiments are within the scope of the following claims.

What is claimed is:

1. A method comprising:
receiving a request to generate an advertisement for an advertisement campaign of an entity and an advertisement request for presentation of the advertisement;
receiving campaign information associated with the entity including receiving local business information associated with the entity;
identifying geographic data related to the advertisement request including determining an intersection of the geographic data and the local business information;
automatically, without user intervention, generating one or more keywords to be associated with the advertisement based on the received campaign information;
generating the advertisement based on the campaign information and the one or more generated keywords;
automatically, without user intervention, managing the advertisement campaign including adjusting one or more bids associated with the one or more generated keywords; and
presenting a local advertisement in response to the advertisement request based on the determined intersection.

2. The method of claim 1, further comprising:
monitoring a traffic pattern associated with the advertisement; and
modifying the one or more generated keywords based on the monitored traffic pattern.

3. The method of claim 1, wherein:
receiving campaign information includes receiving budget information from the entity; and
adjusting the one or more bids includes modifying the one or more bids based on the received budget information.

4. The method of claim 3, wherein modifying the one or more bids is performed based on the received budget information and the local business information without user intervention.

5. The method of claim 4, further comprising:
receiving an ad request;
identifying one or more sources from which the ad request is received; and
presenting the advertisement in response to the ad request if the one or more sources overlap the local business information.

6. The method of claim 1, wherein:
receiving campaign information includes receiving information identifying one or more business categories associated with the entity; and
generating the one or more keywords is performed based on the received campaign information including the one or more identified business categories.

7. The method of claim 1, wherein adjusting the one or more bids includes:
presenting one or more budget recommendations to the entity, each budget recommendation identifying a corresponding budget and an estimated budget performance associated with the corresponding budget;
receiving a user selection of a budget recommendation; and
adjusting the one or more bids based on the selected budget recommendation.

8. A computer-readable medium having instructions stored thereon, which, when executed by a processor, causes the processor to perform operations comprising:
receiving a request to generate an advertisement for an advertisement campaign of an entity and an advertisement request for presentation of the advertisement;
receiving campaign information associated with the entity including receiving local business information associated with the entity;
identifying geographic data related to the advertisement request including determining an intersection of the geographic data and the local business information;
automatically, without user intervention, generating one or more keywords to be associated with the advertisement based on the received campaign information;
generating the advertisement based on the campaign information and the one or more generated keywords;
automatically, without user intervention, managing the advertisement campaign including adjusting one or more bids associated with the one or more generated keywords; and
presenting a local advertisement in response to the advertisement request based on the determined intersection.

9. The computer-readable medium of claim 8, further operable to cause the processor to perform operations comprising:
monitoring a traffic pattern associated with the advertisement; and
modifying the one or more generated keywords based on the monitored traffic pattern.

10. The computer-readable medium of claim 8, wherein:
receiving campaign information includes receiving budget information from the entity; and
adjusting the one or more bids includes modifying the one or more bids based on the received budget information.

11. The computer-readable medium of claim 10, wherein modifying the one or more bids is performed based on the received budget information and the local business information without user intervention.

12. The computer-readable medium of claim 11, further operable to cause the processor to perform operations comprising:
receiving an ad request;
identifying one or more sources from which the ad request is received; and
presenting the advertisement in response to the ad request if the one or more sources overlap the local business information.

13. The computer-readable medium of claim 8, wherein:
receiving campaign information includes receiving information identifying one or more business categories associated with the entity; and
generating the one or more keywords is performed based on the received campaign information including the one or more identified business categories.

14. The computer-readable medium of claim 8, wherein adjusting the one or more bids includes:
presenting one or more budget recommendations to the entity, each budget recommendation identifying a corresponding budget and an estimated budget performance associated with the corresponding budget;
receiving a user selection of a budget recommendation; and
adjusting the one or more bids based on the selected budget recommendation.

15. A system comprising:
an advertisement manager to:
generate an interface and receive, through the interface, a request to generate an advertisement for an advertisement campaign of an entity, and campaign information associated with the entity;
a keyword generator to automatically, without user intervention, generate one or more keywords to be associated with the advertisement based on the received campaign information; and
a bid manager to automatically, without user intervention, manage the advertisement campaign and adjust one or more bids associated with the one or more generated keywords.

16. The system of claim 15, wherein:
the interface is configured to:
receive local business information associated with the entity,
identify geographic data related to the advertisement request, and
determine an intersection of the geographic data and the local business information.

17. The system of claim 16, wherein the advertisement manager is configured to:
generate the advertisement based on the campaign information and the one or more generated keywords; and
present a local advertisement in response to the advertisement request based on the determined intersection.

18. The system of claim 16, wherein the advertisement manager is configured to:
monitor a traffic pattern associated with the advertisement; and
modify the one or more generated keywords based on the monitored traffic pattern.

19. The system of claim 16, wherein:
the campaign information includes budget information from the entity; and
the bid manager is configured to modify the one or more bids based on the received budget information.

20. The system of claim 19, wherein:
the bid manager is configured to modify the one or more bids based on the received budget information and the local business information without user intervention.

21. The system of claim 16, wherein:
the interface is configured to receive information identifying one or more business categories associated with the entity; and
the keyword generator is configured to generate the one or more keywords based on the received campaign information and the one or more identified business categories.

22. The method of claim 16, wherein:
the interface is configured to:
present one or more budget recommendations to the entity, each budget recommendation identifying a corresponding budget and an estimated budget performance associated with the corresponding budget,
receive a user selection of a budget recommendation; and
the bid manager is configured to adjust the one or more bids based on the selected budget recommendation.
